(19) United States
(12) Patent Application Publication
(10) Pub. No.: US 2026/0171684 A1
(43) Pub. Date: Jun. 18, 2026

(54) 2-POLE INSULATION PIERCING CONNECTOR

(71) Applicant: Panduit Corp., Tinley Park, IL (US)

(72) Inventors: Russell K. Morrow, Tinley Park, IL (US); Rodney G. Rouleau, Manhattan, IL (US); Sahar Ramahi, Palos Hills, IL (US); Steven J. Baskerville, Romeoville, IL (US); Thuc K. Vu, Plainfield, IL (US); Gabriela R. Sims, Gary, IN (US)

(73) Assignee: Panduit Corp., Tinley Park, IL (US)

(21) Appl. No.: 19/354,014

(22) Filed: Oct. 9, 2025

Related U.S. Application Data
(60) Provisional application No. 63/734,239, filed on Dec. 16, 2024.
(60) Provisional application No. 63/734,243, filed on Dec. 16, 2024.
(60) Provisional application No. 63/753,690, filed on Feb. 4, 2025.

(51) Int. Cl. H01R 4/2479; H01R 4/2407; H01R 13/504; H01R 13/506; H01R 13/52; H01R 13/645

(52) U.S. Cl. CPC H01R 4/2479; H01R 4/2407; H01R 13/504; H01R 13/506; H01R 13/5219; H01R 13/6456

(57) ABSTRACT

A 2-pole keyed insulation piercing connector (IPC) is disclosed for enabling proper mating connections. The 2-pole keyed IPC is further configured to provide weather tight protection from moisture intrusion provide UV resistant protection. Within a polar panel installation system, the 2-pole keyed IPC is used to connect both positive and negative poles of polar panel strings to the positive and negative main run cables.

### CROSS-REFERENCE TO RELATED APPLICATION(S)

This application claims benefit to U.S. Provisional Ser. No. 63/734,239, filed Dec. 16, 2024, and claims benefit to U.S. Provisional Ser. No. 63/734,243, filed Dec. 16, 2024, and claims benefit to U.S. Provisional Ser. No. 63/753,690 , filed Feb. 4, 2025, the entirety of all of which are hereby incorporated by reference herein.

### TECHNICAL FIELD

This application relates to a 2-pole insulation piercing connector that may, for example, be used in a solar panel installation application to ensure safe transmission of electrical power.

### BACKGROUND

The solar energy industry is rapidly expanding, with solar farms being developed at an increasing rate. As these farms continue to grow and develop, so does the opportunity to improve safety and efficiency in the electrical connections linking solar panels.

In solar energy farm applications, there are long runs of large gauge conducting cables to which smaller gauge solar panel cables need to be connected (i.e., branches). It may be impractical to strip the insulation from the main run cable, so devising a way to pierce the insulation of the main run cables to connect the branch wires would be preferred. These connections should be secure, easy to install, provide waterproof tap connections, and protect the conducting metals in the cables from outdoor elements. Existing commercially available solutions are oftentimes expensive as well as difficult and time-consuming to install.

### SUMMARY

Disclosed herein is a 2-pole insulation piercing connector (IPC) for enabling proper mating connections for maintaining proper polarity. The 2-pole keyed IPC is further configured to provide weather tight protection from moisture intrusion provide UV resistant protection. Within a solar panel installation system, the 2-pole keyed IPC may be used to connect both positive and negative poles of solar panel strings to positive and negative main run cables used in the system.

According to some embodiments, an insulation piercing connector for managing polarity of a first main cable and a second main cable is disclosed. The insulation piercing connector includes a main body enclosure including a first set of blades configured to pierce a first cable and a second set of blades configured to pierce a second cable, a first end assembly including a top row including a first pole receptacle and a second row including a second pole receptacle configured to couple to the first set of blades, a second end assembly including a top row including a second pole receptacle and a second row including a first pole receptacle configured to couple to the second set of blades, and a cable clamp configured to engage with the main body enclosure to clamp down on the first cable and the second cable to abut against the first set of blades and the second set of blades.

According to some embodiments, an insulation piercing connector for managing polarity of a first main cable and a second main cable is disclosed. The insulation piercing connector includes a main body comprising: a first channel configured to receive a first cable, the first channel including a first opening; a second channel configured to receive a second cable, the second channel including a second opening; and an internal housing configured to house a first bus bar including a first insulation piercing blade protruding out of the first opening, and a second bus bar including a second insulation piercing blade protruding out of the second opening; a first end assembly comprising: a top row including a first pole receptacle configured to couple to the first bus bar; and a bottom row including a second pole receptacle configured to couple to the second bus bar; a second end assembly comprising: a top row including a second pole receptacle configured to couple to the second bus bar; and a bottom row including a first pole receptacle configured to couple to the first bus bar; and a cable clamp configured to engage with the main body to clamp down on the first cable housed in the first channel such that the first insulation piercing blade pierces the first cable, and clamp down on the second cable housed in the second channel such that the second insulation piercing blade pierces the second cable.

A detailed description of these and other non-limiting exemplary embodiments of the insulation piercing connector is set forth below together with accompanying drawings.

### BRIEF DESCRIPTION OF THE DRAWINGS

FIG. 1 shows a perspective view of an insulation piercing connector, according to an embodiment of the present disclosure.

FIG. 2 shows an exploded perspective view of components included in a primary terminal pin assembly to a first end assembly of the insulation piercing connector shown in FIG. 1, according to an embodiment of the present disclosure.

FIG. 3 shows an exploded perspective view of components included in a secondary terminal pin to the first end assembly of the insulation piercing connector shown in FIG. 1, according to an embodiment of the present disclosure.

FIG. 4 shows an exploded perspective view of components included in the first end assembly of the insulation piercing connector shown in FIG. 1, according to an embodiment of the present disclosure.

FIG. 5 shows an exploded perspective view of the first end assembly in a state of installation into a main body of the insulation piercing connector shown in FIG. 1, according to an embodiment of the present disclosure.

FIG. 6A shows a perspective view of a connecting strap assembly for a top row of the first end assembly of the insulation piercing connector shown in FIG. 1, according to an embodiment of the present disclosure.

FIG. 6B shows a perspective view of a connecting strap assembly for a bottom row of the first end assembly of the insulation piercing connector shown in FIG. 1, according to an embodiment of the present disclosure.

FIG. 7 shows an exploded perspective view of a second end assembly in a state of installation into the main body of the insulation piercing connector shown in FIG. 1, according to an embodiment of the present disclosure.

FIG. 8A shows a front-side view of a first polarity connector receptable of the insulation piercing connector shown in FIG. 1, according to an embodiment of the present disclosure.

FIG. 8B shows a front-side view of a second polarity connector receptable of the insulation piercing connector shown in FIG. 1, according to an embodiment of the present disclosure.

FIG. 9A shows a first side-view of the insulation piercing connector shown in FIG. 1 where a first cable is shown to have been installed, according to an embodiment of the present disclosure.

FIG. 9B shows a second side-view of the insulation piercing connector shown in FIG. 1 where a second cable is shown to have been installed, according to an embodiment of the present disclosure.

FIG. 10 shows an exploded perspective view of the insulation piercing connector shown in FIG. 1 in a pre-assembly state for the first cable and the second cable, according to an embodiment of the present disclosure.

FIG. 11 shows a side view of the insulation piercing connector shown in FIG. 1 in a mid-assembly state for the first cable and the second cable, according to an embodiment of the present disclosure.

FIG. 12 shows a side view of the insulation piercing connector shown in FIG. 1 in a fully-assembled state for the first cable and the second cable, according to an embodiment of the present disclosure.

FIG. 13 shows a perspective view of the first end of the insulation piercing connector shown in FIG. 1 where a number of connectors are also shown for installation into the first end of the insulation piercing connector, according to an embodiment of the present disclosure.

FIG. 14 shows a perspective view of an alternative insulation piercing connector, according to an alternative embodiment of the present disclosure.

FIG. 15A shows a front-side view of a first polarity connector receptable of the insulation piercing connector shown in FIG. 14, according to an embodiment of the present disclosure.

FIG. 15B shows a front-side view of a second polarity connector receptable of the insulation piercing connector shown in FIG. 14, according to an embodiment of the present disclosure.

FIG. 16A shows a first side-view of the insulation piercing connector shown in FIG. 1 where a first cable is shown to have been installed, according to an embodiment of the present disclosure.

FIG. 16B shows a second side-view of the insulation piercing connector shown in FIG. 14 where a second cable is shown to have been installed, according to an embodiment of the present disclosure.

FIG. 17 shows an exploded perspective view of the insulation piercing connector shown in FIG. 15, according to an embodiment of the present disclosure.

FIG. 18 shows an exploded perspective view of components included in a first end assembly of the insulation piercing connector shown in FIG. 14, according to an embodiment of the present disclosure.

FIG. 19 shows an exploded perspective view of components included in a terminal pin assembly to the first end assembly of the insulation piercing connector shown in FIG. 14, according to an embodiment of the present disclosure.

FIG. 20 shows a perspective view of four over-molded IPC bodies included inside a main body enclosure of the insulation piercing connector shown in FIG. 14, according to an embodiment of the present disclosure.

FIG. 21 shows a perspective view of one over-molded IPC body taken from FIG. 20, according to an embodiment of the present disclosure.

FIG. 22 shows a partial perspective view of the insulation piercing connector shown in FIG. 14 to demonstrate how the first end assembly is installed onto the main body enclosure of the insulation piercing connector shown in FIG. 14, according to an embodiment of the present disclosure.

FIG. 23 shows an exploded perspective view of the insulation piercing connector shown in FIG. 14 in a pre-assembly state for the first cable and the second cable, according to an embodiment of the present disclosure.

FIG. 24 shows a side view of the insulation piercing connector shown in FIG. 14 in a mid-assembly state for the first cable and the second cable, according to an embodiment of the present disclosure.

FIG. 25 shows a side view of the insulation piercing connector shown in FIG. 14 in a fully-assembled state for the first cable and the second cable, according to an embodiment of the present disclosure.

FIG. 26 shows a perspective view of the first end of the insulation piercing connector shown in FIG. 14 where a number of connectors are also shown for installation into the first end of the insulation piercing connector, according to an embodiment of the present disclosure.

FIG. 27 shows a perspective view of an alternative insulation piercing connector having a single-piece over molded body, according to an alternative embodiment of the present disclosure.

FIG. 28 shows a perspective view of the alternative insulation piercing connector shown in FIG. 27, according to an alternative embodiment of the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

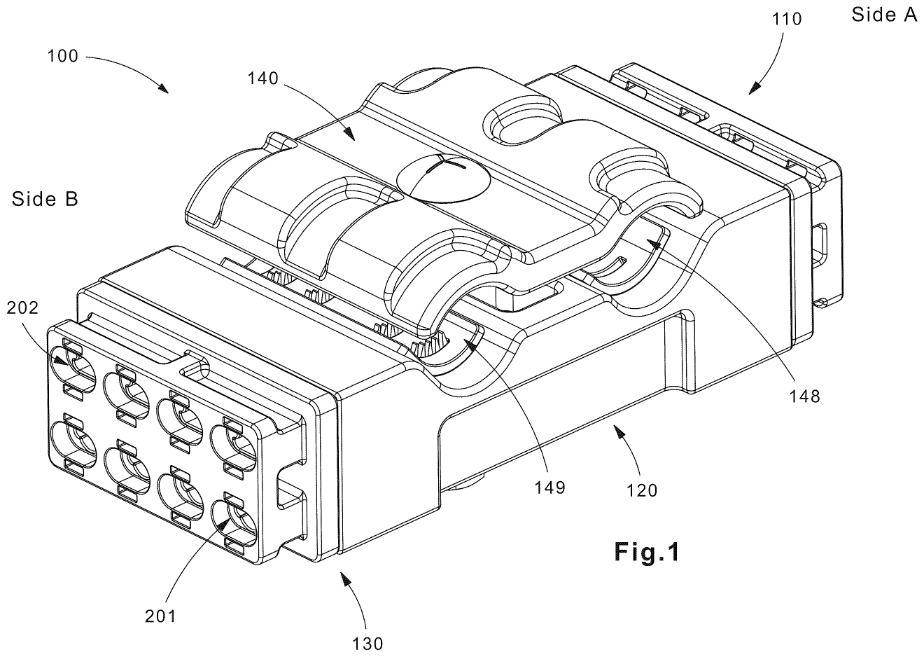

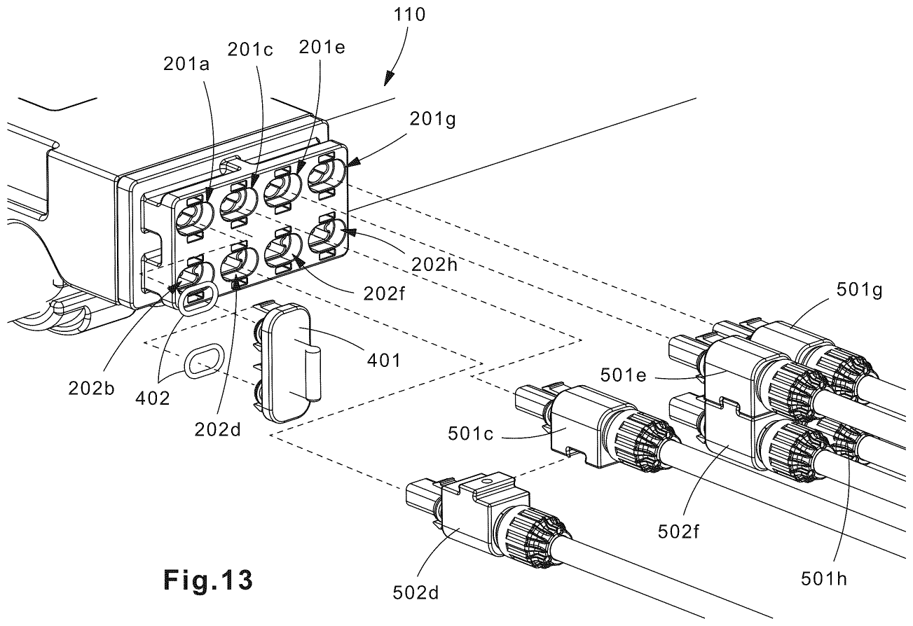

Disclosed herein is a 2-pole keyed insulation piercing connector (IPC) 100 that helps ensure proper mating connections, as shown, for example, in FIG. 1. The 2-pole keyed IPC 100 is configured to further provide weather tight protection from moisture intrusion and may be made from a material that provides UV resistant protection. Within a polar panel installation system, the 2-pole keyed IPC 100 is configured to connect both positive and negative poles of polar panel strings to the positive and negative main run wire, as shown, for example, in FIG. 13.

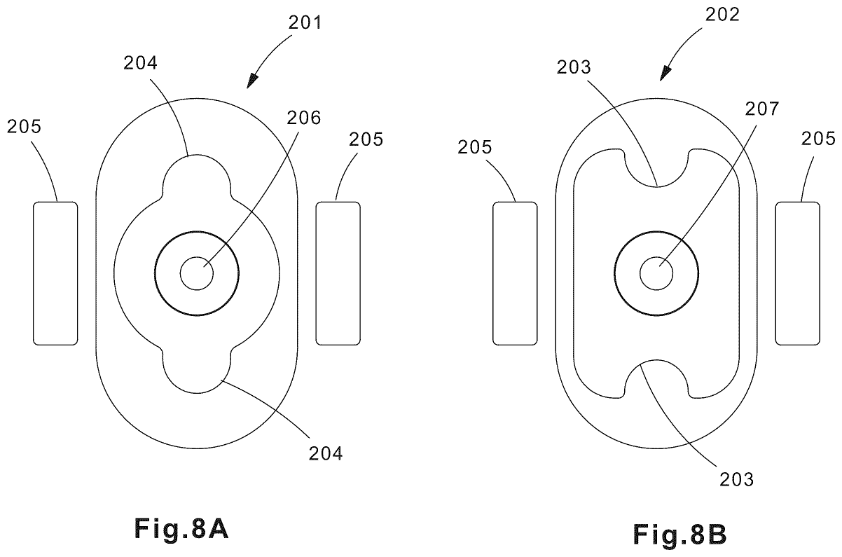

FIG. 1 shows a perspective view of a 2-pole keyed IPC 100 according to an embodiment. The 2-pole keyed IPC 100 includes a main body enclosure 120, a first end assembly 110 positioned at a first side A, a second end assembly 130 positioned at a second side B, and a cable clamp 140. Each of the first end assembly 110 and the second end assembly 130 includes a number of receptacles, including a first pole receptacle 201 and a second pole receptacle 202. The first pole receptacle 201 includes a unique key-up feature 204, as further shown in FIG. 8A. And the second pole receptacle 202 includes a unique key-down feature 203, as further shown in FIG. 8B.

As shown in FIG. 1 and FIGS. 10-12, the 2-pole keyed IPC 100 includes a first channel 148 for holding a first main run cable 301 (e.g., negative pole, red) and a second channel 149 for holding a second main run cable 302 (e.g., positive, black). The 2-pole keyed IPC 100 further includes insulation piercing blades 15 that push up into the first channel 148 and the second channel 149 to pierce through the insulation jacket of the first main run cable 301 and the second main run cable 302 held within the first channel 148 and the second channel 149, respectively. These insulation piercing blades 15 may then initiate an electrical path inside the 2-pole keyed IPC 100 for coupling the first main run cable 301 and the second main run cable 302 to keyed safety connectors that are inserted into the first pole receptacle 201 and the second pole receptacle 202, where the keyed safety connectors are terminations to conductor wires from one or more solar panel strings. For example, when there are 8 solar panel strings, each solar panel string will include a conductor wire pair (e.g., one positive pole conductor wire and one negative pole conductor wire), so that up to four conductor wire pairs may be inserted into the receptacles 201, 202 included in the first end assembly 110, and up to four conductor wire pairs may be inserted into the receptacles 201, 202 included in the second end assembly 130. The keyed safety connectors may include the same keyed features as the receptacles 201, 202 to ensure an installer is connecting the correct polarity of the solar panel strings to the correct polarity of the main run cables 301, 302.

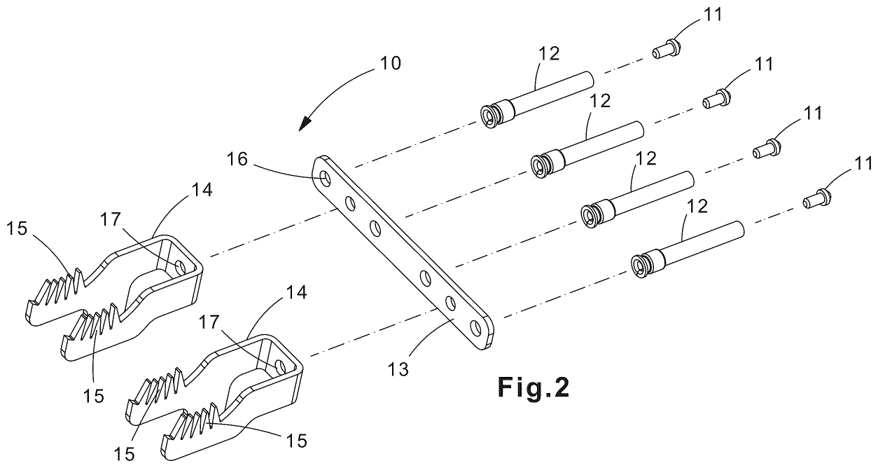

To describe the electrical path provided inside the 2-pole keyed IPC 100 in more detail, FIG. 2 shows an exploded perspective view of a primary terminal pin assembly 10 that may be included in the first end assembly 110. The primary terminal pin assembly 10 includes four tubular terminal pins 12, where each of the four tubular terminal pins 12 are positioned within a corresponding receptacle 201, 202 to electrically couple with a keyed safety connector sharing the same key feature. So, the number of tubular terminal pins 12 will correspond to the number of receptacles 201, 202 in a first row of the first end assembly 110. The primary terminal pin assembly 10 further includes four terminal pin safety guards 11, where each of the four terminal pin safety guards 11 are configured to attach to a first end of a corresponding tubular terminal pins 12, to assist in preventing arcing when a keyed safety connector is inserted into the receptacles 201, 202. The tubular terminal pins 12 may be made from copper, or other conductive metal material.

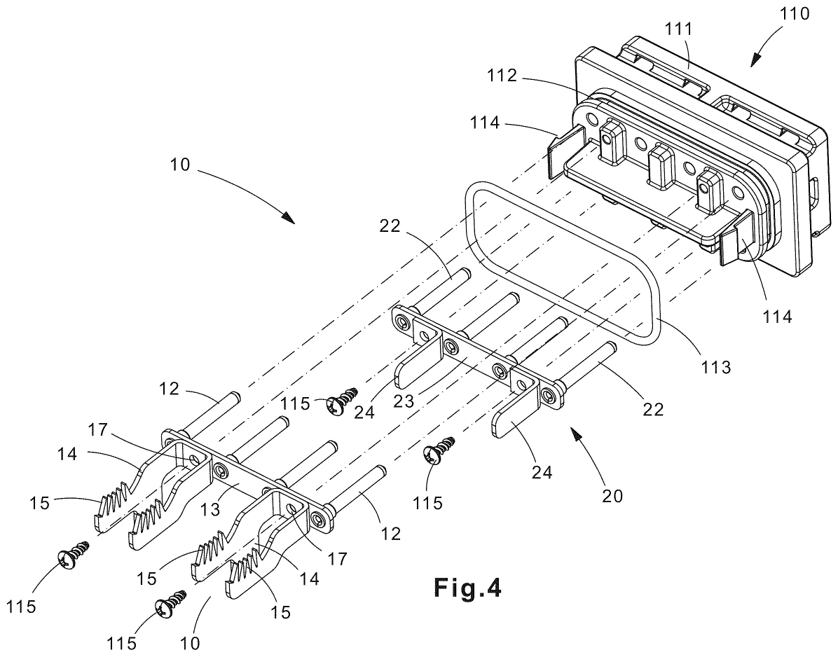

The primary terminal pin assembly 10 further includes a terminal strip 13 and a number of insulation piercing blades 14. The terminal strip 13 includes a plurality (e.g., six) of holes 16. Each of the insulation piercing blades 14 include insulation piercing blades 15 (e.g., there are four insulation piercing blades 15 total, where each insulation piercing blade 14 includes two insulation piercing blades 15). Each of the insulation piercing blades 14 also include a fastener hole 17, where a fastener (e.g., self-tapping screw) 115 is threaded through the fastener hole 17 and one of the holes 16 in the terminal strip 13 to secure the insulation piercing blades 14 to the terminal strip 13, as shown, for example, in FIG. 4. The insulation piercing blades 14 may be made from copper, or other conductive metal material, to enable transfer of electrical power from the insulation piercing blades 14 to the tubular terminal pins 12.

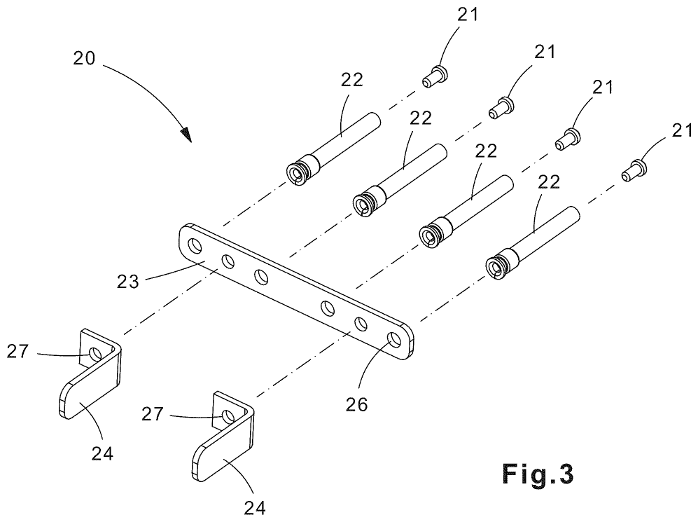

Because the 2-pole keyed IPC 100 is configured to connect both the positive and negative poles of the polar panel strings to the positive main run cable 301 and the negative main run cable 302, the keyed safety connector that is not electrically coupled to the insulation piercing blades 15 is passed through to the other side of the 2-pole keyed IPC 100. So for example, for the keyed safety connectors that are installed into the second row and not electrically coupled to the insulation piercing blades 15 at the first end assembly 110 on side A, they will be electrically coupled to insulation piercing blades 15 that are coupled to the second end assembly 130 on side B. This pass-through is provided by the components included in a secondary terminal pin assembly m that is also included in the first end assembly 110, as shown in FIG. 3.

FIG. 3 shows an exploded perspective view of the secondary terminal pin assembly 20 that may also be included in the first end assembly 110. The secondary terminal pin assembly 20 includes four tubular terminal pins 22, where each of the four tubular terminal pins 22 are positioned within a corresponding receptacle to electrically couple with a keyed safety connector sharing the same key feature. So, the number of tubular terminal pins 22 will correspond to the number of receptacles in a second row of the first end assembly 110. The secondary terminal pin assembly 20 further includes four terminal pin safety guards 21, where each of the four terminal pin safety guards 21 are configured to attach to a first end of a corresponding tubular terminal pins 22, to assist in preventing arcing when a keyed safety connector is inserted into the receptacles 201, 202. The tubular terminal pins 22 may be made from copper, or other conductive metal material. Please note that the receptacles corresponding to the tubular terminal pins 22 from the primary terminal pin assembly 10 form a first row, while the receptacles corresponding to the tubular terminal pins 22 from the secondary terminal pin assembly 20 form a second row.

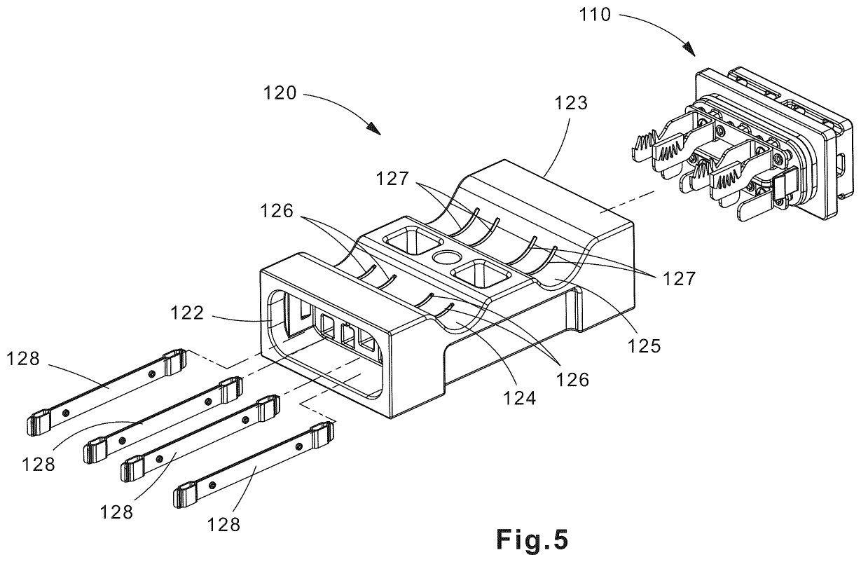

The secondary terminal pin assembly 20 further includes a terminal strip 23 and a number of crossover tabs 24. The terminal strip 23 includes a plurality (e.g., six) of holes 26. Each of the crossover tabs 24 include a tab body 25 for coupling with a connecting strap 128, as shown in FIG. 5. Each of the crossover tabs 24 also include a fastener hole 27, where a fastener (e.g., self-tapping screw) 115 is threaded through the fastener hole 27 and one of the holes 26 in the terminal strip 23 to secure the crossover tabs 24 to the terminal strip 23, as shown, for example, in FIG. 4. The crossover tabs 24 may be made from copper, or other conductive metal material, to enable transfer of electrical power from the crossover tabs 24 to the tubular terminal pins 22.

FIG. 4 shows an exploded perspective view of a portion of the first end assembly 110. The first end assembly 110 includes an end cap housing 111, an O-ring groove 112, end cap retainer clips 114 for inserting into corresponding clip receiver openings on the main body 121, and an O-ring seal 113 for installing into the O-ring groove 112 to provide a water resistant seal when the first end assembly 110 is installed onto a first side opening 123 of the main body enclosure 120.

FIG. 5 shows a partially exploded view of the first end assembly 110 and the main body enclosure 120. The first end assembly 110 is shown assembled and ready for installing into the first side opening 123 of the main body enclosure 120. On side B, four of the connecting strap 128 are shown that will couple to four corresponding receptacles 201, 202 on the second end assembly 130, pass through the inside of a main body 121 of the main body enclosure 120, and attach to the crossover tabs 24 on the first end assembly 110.

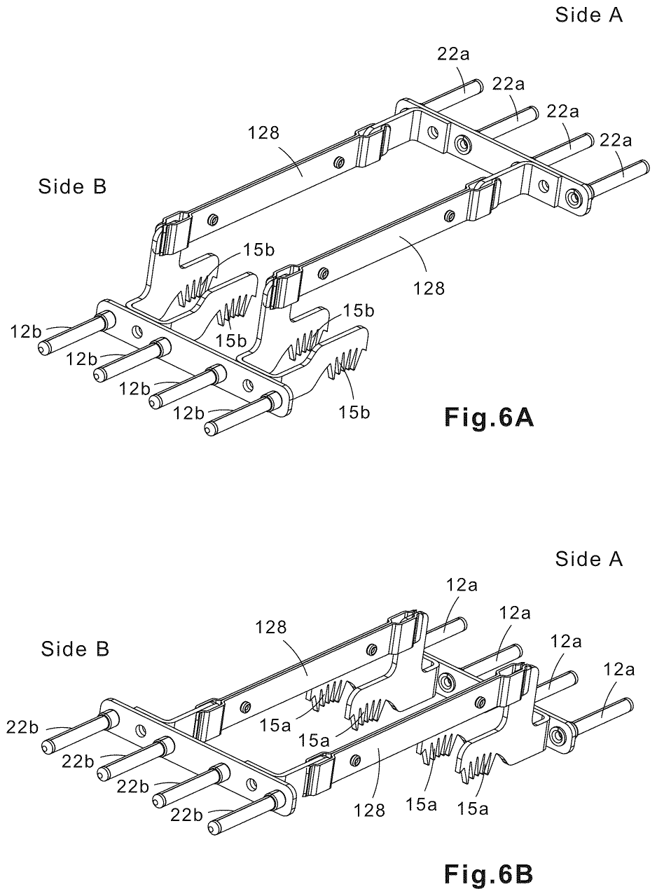

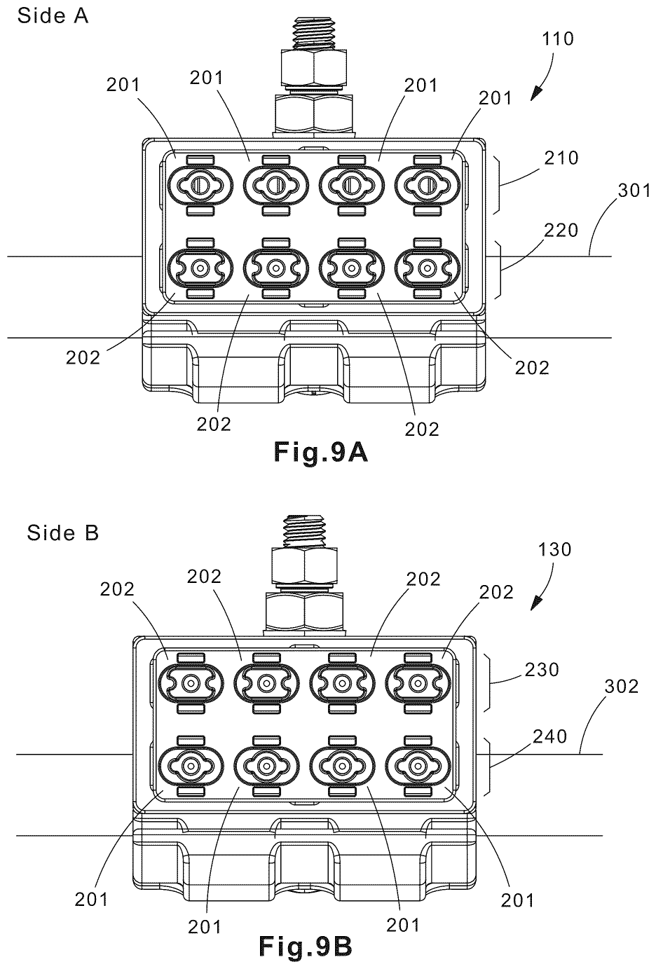

FIGS. 6A and 6B show a perspective view of components that provide the electrical pass-through feature of the 2-pole keyed IPC 100. In the embodiment shown in FIG. 6A, the tubular terminal pins 22a at side A may correspond to first pole receptacles 201 on the first end assembly 110. For example, FIG. 9A shows a side view of the first end assembly 110 at side A, where a first row 210 includes first pole receptacles 201 that may be coupled to the tubular terminal pins 22a within the first end assembly 110. In the embodiment shown in FIG. 6B, the tubular terminal pins 12a at side A may correspond to second pole receptacles 202 on the first end assembly 110. For example, FIG. 9A shows a side view of the first end assembly 110 at side A, where a second (i.e., bottom) row 220 includes second pole receptacles 202 that may be coupled to the terminal pins 12a within the first end assembly 110. As shown by FIG. 6B and FIG. 9A, this bottom row 220 that includes the second pole receptacles 202 are electrically coupled to the terminal pins 12a that are electrically coupled to the insulation piercing blades 15a that are configured to pierce the first main run cable 301. When the first main run cable 301 represents the second pole (e.g., negative), the first end assembly 110 at side A may be representative of a second pole side (e.g., negative pole side). According to other embodiments, the second pole may be representative of the positive pole.

In the embodiment shown in FIG. 6B, the tubular terminal pins 22 b at side B may correspond to second pole receptacles 202 on the second end assembly 130. For example, FIG. 9B shows a side view of the second end assembly 130 at side B, where a first row 230 includes second pole receptacles 202 that may be coupled to the tubular terminal pins 22b within the second end assembly 130. In the embodiment shown in FIG. 6A, the tubular terminal pins 12 b at side B may correspond to first pole receptacles 201 on the second end assembly 130. For example, FIG. 9B shows a side view of the second end assembly 130 at side B, where a second row 240 includes first pole receptacles 201 that may be coupled to the terminal pins 12b within the second end assembly 130. As shown by FIG. 6A and FIG. 9B, this bottom row 240 that includes the first pole receptacles 201 are electrically coupled to the terminal pins 12b that are electrically coupled to the insulation piercing blades 15b that are configured to pierce the second main run cable 302. When the second main run cable 302 represents the first pole (e.g., positive), the second end assembly 130 at side B may be representative of a first pole side (e.g., positive pole side). According to other embodiments, the first pole may be representative of the negative pole.

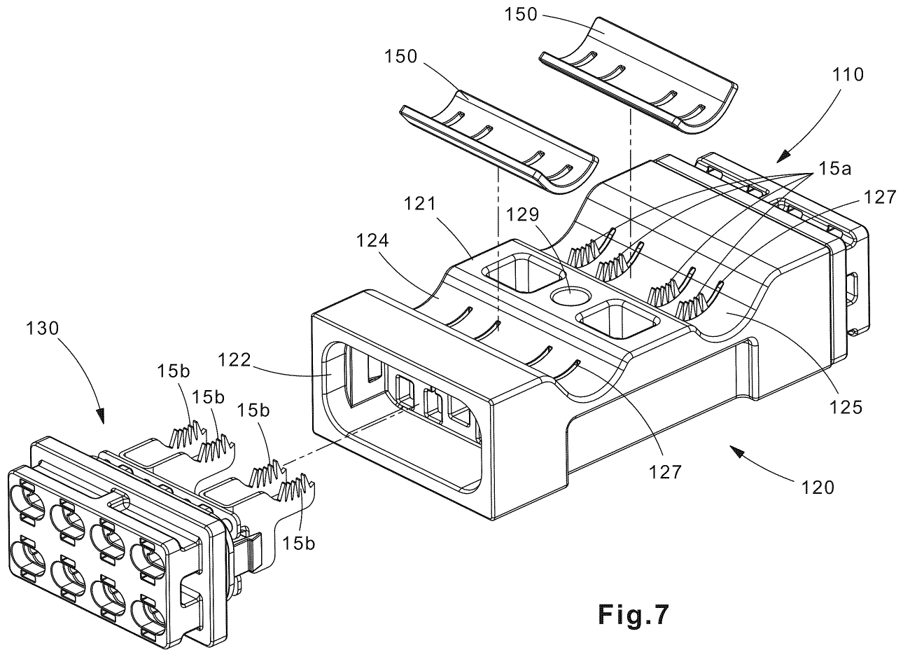

FIG. 7 shows a partially exploded view of the second end assembly 130 and the main body enclosure 120, where the second end assembly 130 is a mirror of the first end assembly 110. The second end assembly 130 is shown to be installed into a second side opening 122 of the main body enclosure 120.

The main body 121 includes blade openings 127 for the insulation piercing blades 15a, 15b to move up through. The blade openings 127 are located within both a first channel half 125 and a second channel half 124. The main body enclosure 120 further includes blade seal pads 150 configured to fit within the first channel half 125 and the second channel half 124, where the blade seal pads 150 are made from a compressible material such as a foam, polymer, or plastic material. The blade seal pads 150 also include slits that line up to the blade openings 127.

FIG. 8A shows a front-side view of the first pole receptacle 201 that may be included on the first end assembly 110 and/or the second end assembly 130. The first pole receptacle 201 includes key-up features 204 for receiving a first pole keyed safety connector 501c including corresponding key-up features for fitting within the first pole receptacle 201. An example of a first pole safety connector 501c is shown in FIG. 13. The first pole receptacle 201 also includes a conductor opening 206 for receiving a conductor tip of the first pole safety connector 501c that will couple to, for example, the tubular terminal pins 12b, 22a for passing through electrical transmissions tapped from the second main run cable 302 via the insulation piercing blades 15b. The first pole receptacle 201 also includes alignment latch openings 205 to receive alignment latches that may be included in the first pole keyed safety connector 501c.

FIG. 8B shows a front-side view of the second pole receptacle 202 that may be included on the first end assembly 110 and/or the second end assembly 130. The second pole receptacle 202 includes key-down features 203 for receiving a second pole keyed safety connector 501d including corresponding key-down features for fitting within the second pole receptacle 202. An example of a second pole safety connector 501d is shown in FIG. 13. The second pole receptacle 202 also includes a conductor opening 207 for receiving a conductor tip of the second pole safety connector 501d that will couple to, for example, the tubular terminal pin 12a, 22b for passing through electrical transmissions tapped from the first main run cable 301 via the insulation piercing blades 15a. The first pole receptacle 201 also includes alignment latch openings 205 to receive alignment latches that may be included in the first pole keyed safety connector 501c.

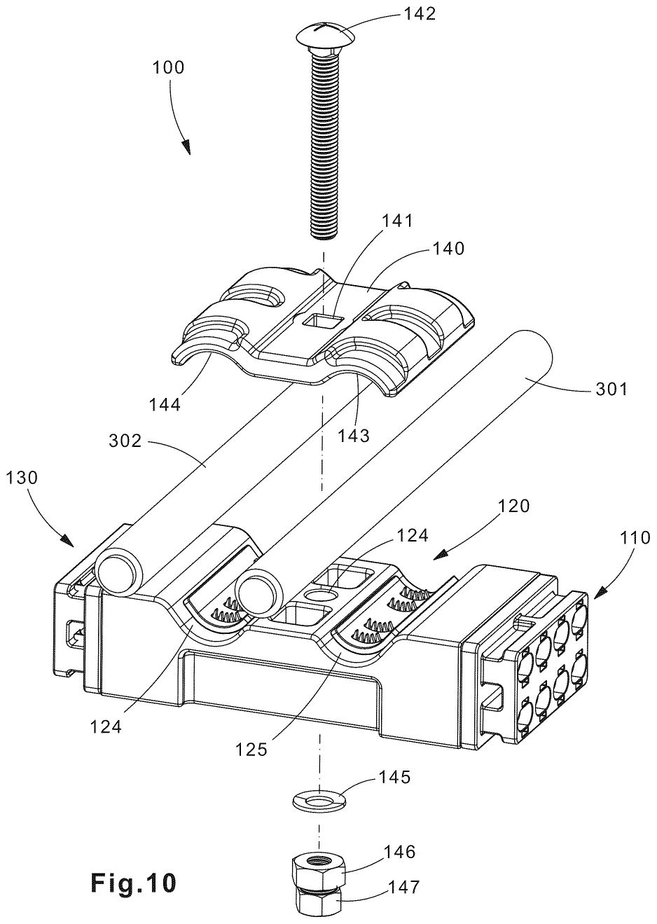

FIG. 10 shows an exploded perspective view of the 2-pole keyed IPC 100, where the first main run cable 301 and the second main run cable 302 are positioned to fit within the first channel 148 and the second channel 149, respectively, in a pre-assembly state. A bottom half of the first channel 148 is formed by the first channel half 125 of the main body enclosure 120 and a top half of the first channel 148 is formed by a first channel half 143 of the cable clamp 140. A bottom half of the second channel 149 is formed by the second channel half 124 of the main body enclosure 120 and a top half of the second channel 149 is formed by a second channel half 144 of the cable clamp 140.

FIG. 10 further shows a fastener 142 (e.g., a carriage bolt) configured to fit through a pass-through hole 141 in the cable clamp 140 and a pass-through hole 129 in the main body enclosure 120, to engage with fastener termination components such as a washer 145, a first nut 146, and a second nut 147. According to different embodiments, the fastener termination components may include one or more of the washer 145, the first nut 146, and/or the second nut 147. The first nut 146 and/or the second nut 147 may be breakaway torque limiting buts. In this way, as the fastener termination components are torqued tighter onto the fastener 142, this causes the cable clamp 140 to clamp down and secure the first main run cable 301 in the first channel 148 and secure the second main run cable 302 in the second channel 149.

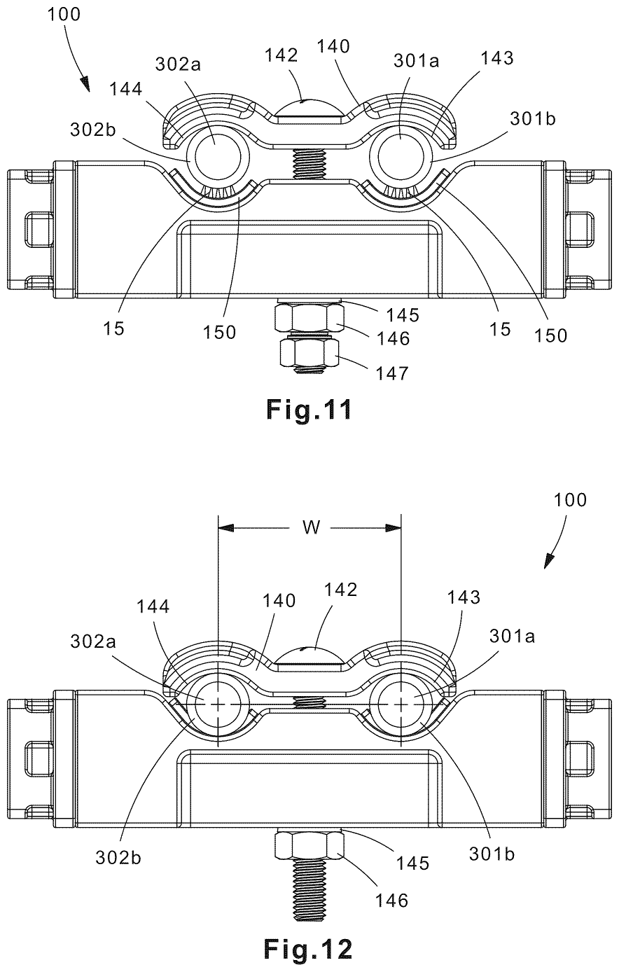

FIG. 11 shows a side view of the 2-pole keyed IPC 100 in a mid-assembly state where the first main run cable 301 is placed into the first channel 148 and the second main run cable 302 is placed into the second channel 149. However, in this mid-assembly state the fastener 142 has not been tightened enough to the nuts 146, 147 for the insulation piercing blades 15 to pierce through the insulation jacket 301b, 302b of the first main run cable 301 and the second main run cable 302.

FIG. 12 shows a side view of the 2-pole keyed IPC 100 in a fully assembled state. In this fully assembled state, the insulation piercing blades 15 have pierced through the insulation jacket 301b, 302b and have made physical contact with the inner conductor 301a, 301b of the first main run cable 301 and the second main run cable 302. A spacing W between the first main run cable 301 and the second main run cable 302 may be 2.50 inches or more. According to other embodiments, the spacing W between the first main run cable 301 and the second main run cable 302 may be 2.50 inches or less.

FIG. 13 shows a perspective view of the 2-pole keyed IPC 100, and in particular the first end assembly 110. As shown in FIG. 13, the first pole receptacle 201a and the second pole receptacle 202b may be covered by a blanking cap 401 used to seal up unused receptacles. O-ring seals 402 may be included for sealing the blanking cap 401 from moisture penetration. Mated safety connectors 501c, 502d may be inserted into the first pole receptacle 201c and the second pole receptacle 202d. Mated safety connectors 501e, 502f may be inserted into the first pole receptacle 201e and the second pole receptacle 202f. Mated safety connectors 501g, 502h may be inserted into the first pole receptacle 201g and the second pole receptacle 202 h. The safety connectors 501c, 502d, 501e, 501f, 501g, 502h may correspond to safety connectors described in U.S. Provisional Patent Application Ser. No. 63/734,243 , filed Dec. 16, 2024, the entirety of which is hereby incorporated by reference herein.

It is noted that embodiments of the 2-pole keyed IPC 100 disclosed herein may be configured to be utilized for a wide variety of main run cable sizes. It follows that the 2-pole keyed IPC 100 is configured to accommodate a range of different cable sizes by being configurable in different sizes to enable a range of different sized first channels 148 and second channels 149 for holding the different cable sizes. It follows that the 2-pole keyed IPC 100 is configured to be used on multiple conductor sizes (350 through 1250 kcmil), voltage ratings (600, 1 k and 2k volts), current ratings, and materials (copper or aluminum). The main run cables 301, 302 used in the 2-pole keyed IPC for these applications may be rated for outdoor service (e.g., IP67 rating). To achieve this IP 67 rating, the cable seal pads 150 included in the 2-pole keyed IPC 100 may be thick and flexible enough to seal a wide variety of cable dimensions. The operation of the 2-pole keyed IPC 100 does not require specialized installation tools and may be mated correctly due to the keyed features.

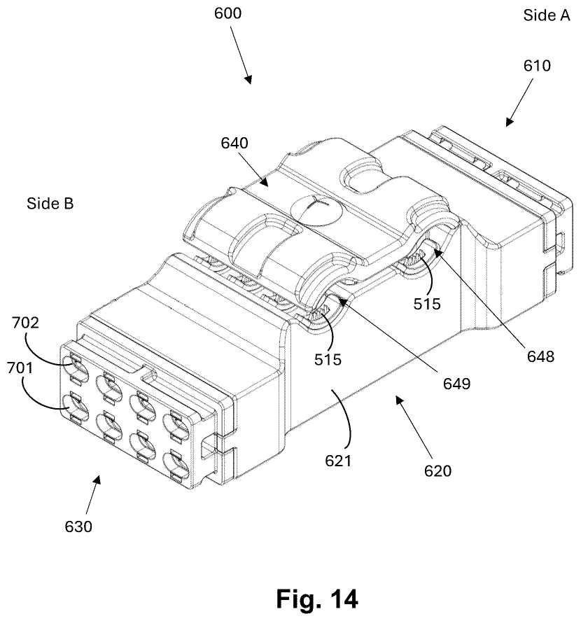

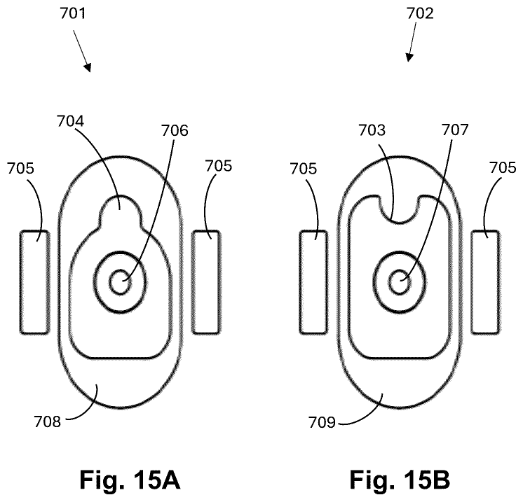

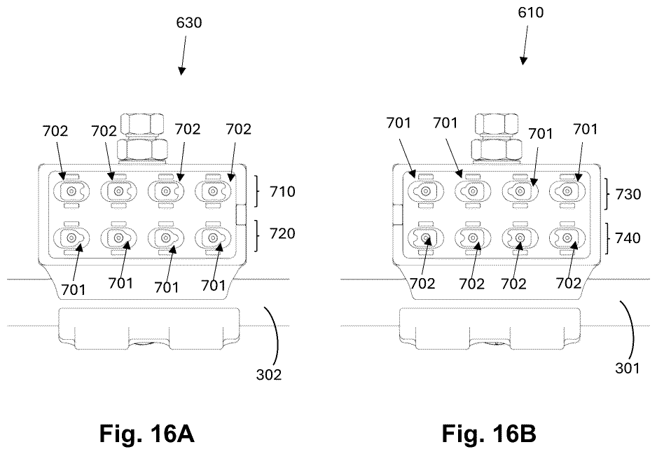

FIG. 14 shows a perspective view of a 2-pole keyed IPC 600 according to an alternative embodiment. Looking at the 2-pole keyed IPC 600 shown in FIG. 14 from the outside, the 2-pole keyed IPC 600 is substantially the same as the 2-pole IPC 100 shown in FIG. 1. The 2-pole keyed IPC 600 includes a main body enclosure 620, a first end assembly 610 positioned at a first side A, a second end assembly 630 positioned at a second side B, and a cable clamp 640. Each of the first end assembly 610 and the second end assembly 630 includes a number of receptacles, including a first pole receptacle 701 and a second pole receptacle 702. The first pole receptacle 701 includes a unique key-up feature 704, as further shown in FIG. 15A. And the second pole receptacle 702 includes a unique key-down feature 703, as further shown in FIG. 15B. FIG. 16A shows a side view of the second end assembly 630 at side B, including a first row 710 of second pole receptacles 702 and a second row 720 of first pole receptacles 701. And FIG. 16B shows a side view of the first end assembly 610 at side A, including a first row 730 of first pole receptacles 701 and a second row 740 of second pole receptacles 702. The bottom row of receptacles (from the perspective shown in FIGS. 16A and 16B) will be electrically coupled to the adjacent blades and main cable. So, for the second end assembly 630, the first pole receptacles 701 in the second row 720 (i.e., bottom row) will be electrically coupled to blades that pierce the second main run cable 302. And for the first end assembly 610, the second pole receptacles 702 in the second row 740 (i.e., bottom row) will be electrically coupled to blades that pierce the first main run cable 301.

The main body enclosure 620 includes primarily a main body 621 that forms an inner housing for housing internal components for tapping into the first main run cable 301 and the second main run cable 302, and transmitting the electrical signal from the first end assembly 610 to the second end assembly 630, and vice versa, as will be described in more detail below. The main body 621, first end assembly 610, second end assembly 630, and cable clamp 640 may be molded from glass-filled nylon.

One updated feature of the 2-pole keyed IPC 600 is the use of different shaped receptacles. For example, the first pole receptacle 701 is designed to include a single key-up feature 704, while the second pole receptacle 702 is designed to include a single key-down feature 703. With this design of having only a single key-up feature 704 or a single key-down feature 703, a corresponding safety connector may be configured to fit in only one orientation. Whereas when there are two mirroring key-up features 204 or two mirroring key-down features 203, a corresponding safety connector may fit in two different orientations that are 180 degrees turned from each other. So, the single key-up feature 704 and the single key-down feature 703 of the receptacles 701, 702 further limits the possibility of installation error. The first pole receptacle 701 may correspond to a first pole (e.g., negative) and the second pole receptacle may correspond to a second pole (e.g., positive). It is noted that according to other embodiments, the polarity of the first pole and the second pole may be reversed.

As seen in FIG. 15A, the first pole receptacle 701 still includes an O-ring bore 708 for holding a sealing O-ring, latch openings 705 for receiving alignment latches from a safety connector, and a conductor opening 706 for receiving a conductor tip of a corresponding first pole safety connector. As seen in FIG. 15B, the second pole receptacle 702 still includes an O-ring bore 709 for holding a sealing O-ring, latch openings 705 for receiving alignment latches from a safety connector, and a conductor opening 707 for receiving a conductor tip of a corresponding first pole safety connector.

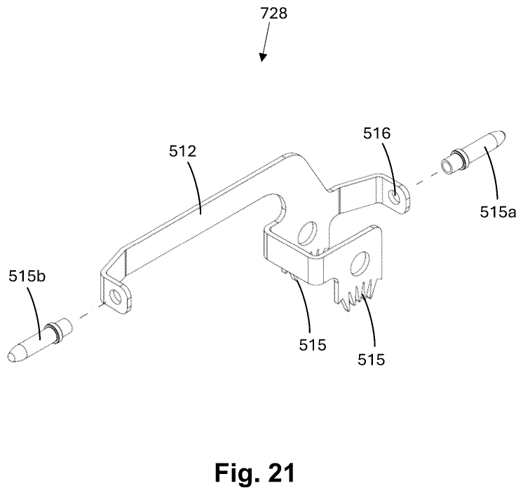

Internally, an updated feature of the 2-pole keyed IPC 600 includes the use of an over-molded blade bus bar 728 that combines an insulation piercing blade and a crossover strip, as shown, for example, in FIG. 21. So whereas the 2-pole keyed IPC 100 included an insulation piercing blades 14 that had to be separately mated to a connecting strap 128, in the 2-pole keyed IPC 600 of the alternative embodiment the blade bus bar 728 is a single piece formed by, for example, over-molding a blade portion and a crossover strip portion.

Referring back to FIG. 14, the 2-pole keyed IPC 600 includes a first channel 648 for holding the first main run cable 301 (e.g., negative pole, red) and a second channel 649 for holding the second main run cable 302 (e.g., positive, black). The 2-pole keyed IPC 600 further includes insulation piercing blades 515 that push up into the first channel 648 and the second channel 649 to pierce through the insulation jacket of the first main run cable 301 and the second main run cable 302 held within the first channel 648 and the second channel 649, respectively. The first channel 648 and the second channel 649 may be designed to accommodate a range of different sized main run cables 301, 302, such as 350 to 750 kcmil aluminum PV cables.

These insulation piercing blades 515 may then initiate an electrical path inside the 2-pole keyed IPC 600 for coupling the first main run cable 301 and the second main run cable 302 to keyed safety connectors that are inserted into the first pole receptacle 701 and the second pole receptacle 702, where the keyed safety connectors are terminations to conductor wires from one or more solar panel strings. For example, when there are 8 solar panel strings, each solar panel string will include a conductor wire pair (e.g., one positive pole conductor wire and one negative pole conductor wire), so that up to four conductor wire pairs may be inserted into the receptacles 701, 702 included in the first end assembly 610, and up to four conductor wire pairs may be inserted into the receptacles 701, 702 included in the second end assembly 630. The keyed safety connectors may include the same keyed features as the receptacles 701, 702 to ensure an installer is connecting the correct polarity of the solar panel strings to the correct polarity of the main run cables 301, 302.

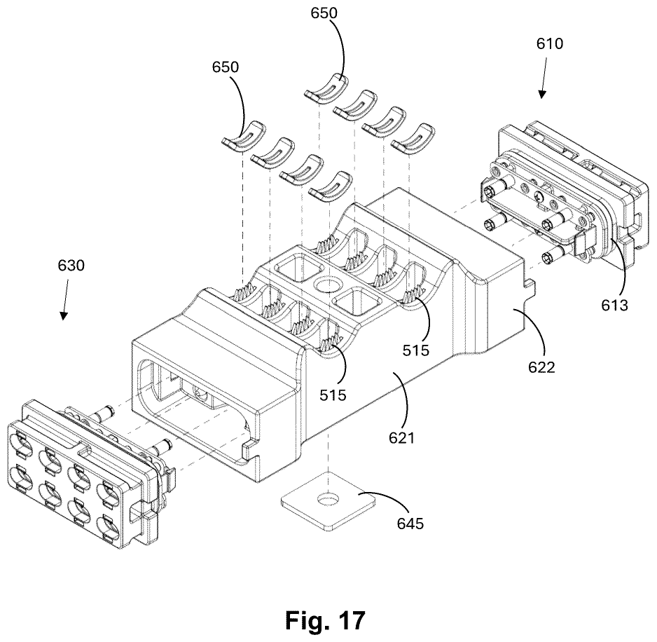

FIG. 17 shows an exploded perspective view of the 2-pole keyed IPC 600 that shows some of the components that enable the 2-pole keyed IPC 600 to be weather resistant up to, for example, achieving an IP67 rating. These weatherproofing components include blade seal pads 650, which prevent water from reaching the insulation piercing blades 515 to cable conductor interface underneath it within the housing of the main body 621, as water intrusion in this location may promote galvanic corrosion which can damage this connection. Another weatherproofing component are the O-ring seals 613 that provide a seal where the first end assembly 610 and the second end assembly 630 are installed into the main body 621. The 2-pole keyed IPC 600 also includes a body reinforcement plate 645.

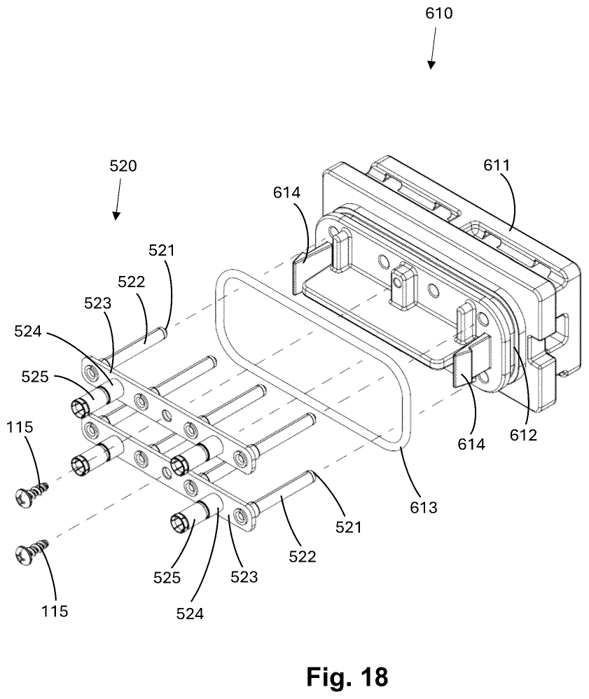

FIG. 18 shows an exploded perspective view of components that may comprise the first end assembly 610. It is noted that the components comprising the second end assembly 630 may mirror the first end assembly 610. The first end assembly 610 includes an end cap housing 611, an O-ring groove 612, end cap retainer clips 614 for inserting into corresponding clip receiver openings on the main body 621, and an O-ring seal 613 for installing into the O-ring groove 612 to provide a water resistant seal when the first end assembly 610 is installed onto a first side opening of the main body enclosure 620.

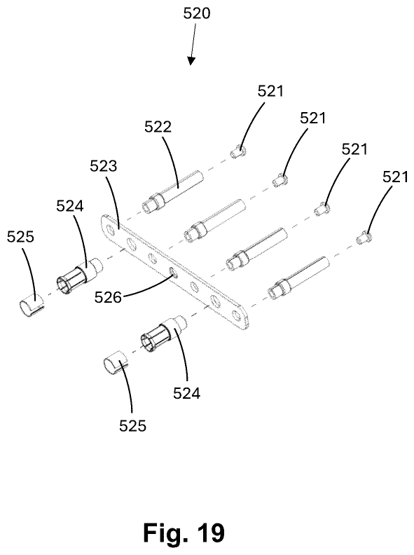

Also shown in FIG. 18 are two terminal pin assemblies 520, a first terminal pin assembly 520 for coupling to the first row 730 and a second terminal pin assembly 520 for coupling to the second row 740. FIG. 19 shows a perspective view of a single terminal pin assembly 520 to help provide an exemplary description. The terminal pin assembly 520 includes a terminal strip 523 that includes a number of holes 526 (e.g., seven (7)) for installing different components. For example, one end of a tubular terminal pin 522 may fit through a hole 526 in the terminal strip, and then a terminal pin safety guard 521 may be inserted into an opposite end of the tubular terminal pin 522. The terminal pin assembly 520 also includes a barrel connector 524 that fit into their own hole 526 in the terminal strip 523. As shown in FIG. 19, a barrel spring 525 is fit around an end of the barrel connector 524. The barrel springs 525 are intended to prevent thermal cycling of the connection which may cause the undesirable result of reducing the contact area of the connection formed between the tubular terminal pin 522 and the barrel connector 524.

The terminal strip 523, tubular terminal pins 522, and/or the barrel connector 524 may be made from a conductive metal such as, for example, copper. The barrel spring 525 may be made from a metal such as, for example, stainless steel. After the tubular terminal pins 522 and the barrel connectors 524 are bonded to the terminal strip 523, they may be tin plated. After tin plating these components of the terminal pin assembly 520, the terminal pin safety guards 521 may be inserted into one end of the tubular terminal pins 522 to prevent accidental contact with the electrically live tubular terminal pins 522 prior to plugging in the safety connectors into their respective receptacles 701, 702 to while the tubular terminal pins 522 will be electrically coupled to. The terminal pin assembly 520 may be secured to the inner side of the first end assembly 610 using the screws 115 to fit through a hole 526 and torqued into a screw opening on the inner side wall of the first end assembly 610.

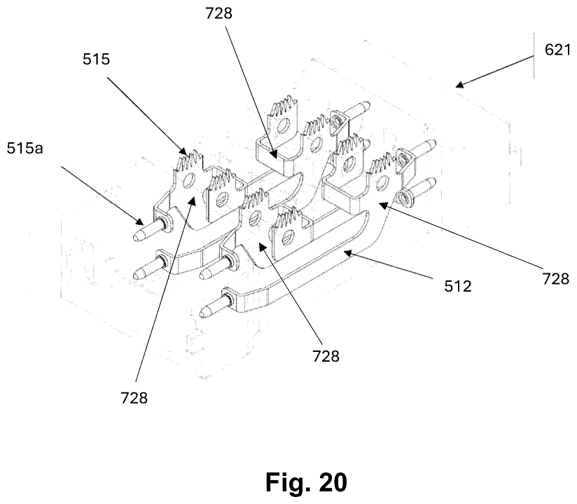

FIG. 20 shows a perspective view of the blade bus bars 728 that are housed inside the main body 621 (dashed outlined) of the main body enclosure 620. FIG. 21 shows a perspective view of a single blade bus bar 728 to help provide an exemplary description. The blade bus bar 728 is comprised of insulation piercing blades 515 configured to pierce the insulation layer of a main run cable 301, 302, and connector pins 515a that are configured to electrically couple to a receptacle at the first end (Side A), and connector pins 515b that are configured to electrically couple to a receptacle at the second end (Side B). The blade bus bars 728 also include a crossover strip 512 for operating as a bus bar to carry the electrical signal from the connector pins 515a at the first side (Side A) to the connector pins 515b at the second side (Side B). As shown in FIG. 20, two blade bus bars 728 are installed at Side A to pierce the first main run cable 301 sitting in the first channel 648, and two blade bus bars 728 are installed at Side B to pierce the second main run cable 302 sitting in the second channel 649. The four blade bus bars 728 shown in FIG. 20 may be inserted into the mold for the main body 621 of the main body enclosure 620. Once inside the main body 621, the four blade bus bars 728 may be over-molded with UV stabilized, glass filled nylon to create the over-molded structure shown in FIG. 20 where the four blade bus bars 728 are molded inside the housing of the main body 621.

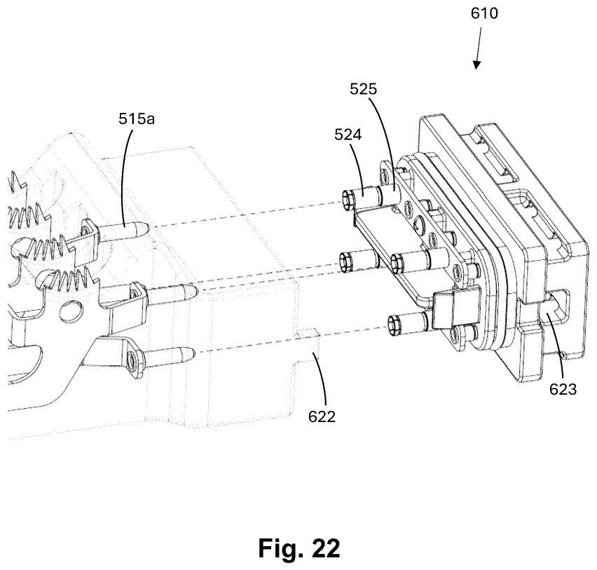

FIG. 22 shows a portion of the 2-pole keyed IPC 600 where the first end assembly 610 is being installed onto the main body enclosure 620. During this installation process, the connector pins 515a from the blade bus bars 728 are configured to fit into the barrel connectors 524 that are part of the terminal pin assembly 520 at the first end assembly 610. The ends of the connector pins 515a, 515b are tapered to ensure positive alignment, and the barrel springs 525 help ensure a strong electrical connection between the connector pins 515a, 515b and the barrel connectors 524. The ends of the main body 621 include alignment tabs 622 that are configured to fit into alignment spaces 623 on the first end assembly 610 and the second end assembly 630, to ensure that each of the first end assembly 610 and the second end assembly 630 are installed in the correct orientation so that positive polarity plugs connector to the positive polarity cable and the negative polarity plugs connect to the negative polarity cable, thus preventing dangerous cross connecting.

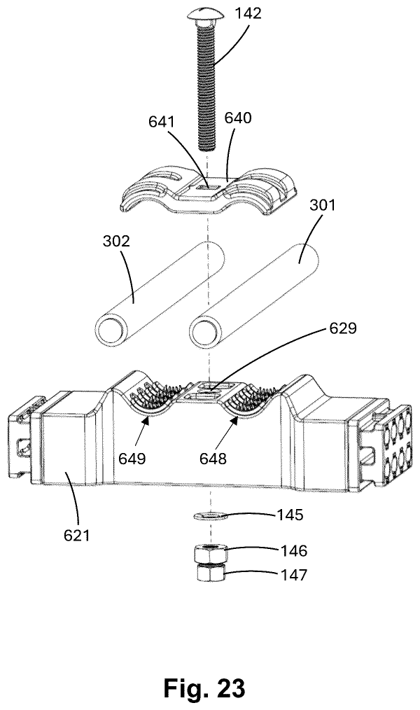

FIG. 23 shows an exploded perspective view of the 2-pole keyed IPC 600, where the first main run cable 301 and the second main run cable 302 are positioned to fit within the first channel 648 and the second channel 649, respectively, in a pre-assembly state. The first channel 648 and the second channel 649 are formed by the main body enclosure 620 and the cable clamp 640.

FIG. 23 further shows a fastener 142 (e.g., a carriage bolt) configured to fit through a pass-through hole 641 in the cable clamp 640 and a pass-through hole 629 in the main body enclosure 620, to engage with fastener termination components such as a washer 145, a first nut 146, and a second nut 147. According to different embodiments, the fastener termination components may include one or more of the washer 145, the first nut 146, and/or the second nut 147. The first nut 146 and/or the second nut 147 may be breakaway torque limiting buts. In this way, as the fastener termination components are torqued tighter onto the fastener 142, this causes the cable clamp 640 to clamp down and secure the first main run cable 301 in the first channel 648 and secure the second main run cable 302 in the second channel 649.

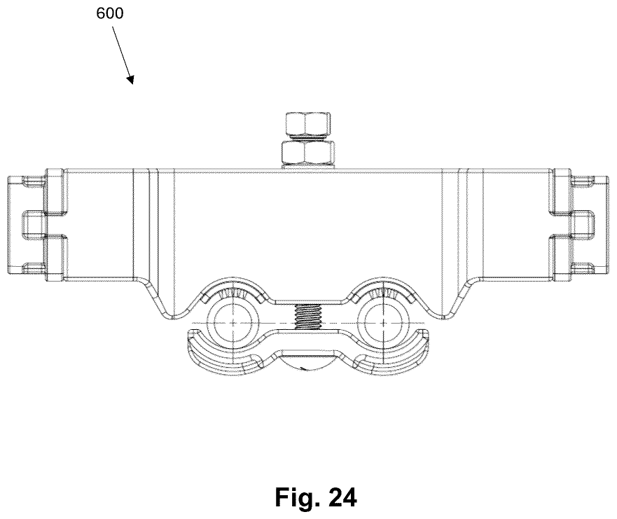

FIG. 24 shows a side view of the 2-pole keyed IPC 600 in a mid-assembly state where the first main run cable 301 is placed into the first channel 648 and the second main run cable 302 is placed into the second channel 649. However, in this mid-assembly state the fastener 142 has not been tightened enough to the nuts 146, 147 for the insulation piercing blades 515 to pierce through the insulation jacket 301b, 302b of the first main run cable 301 and the second main run cable 302.

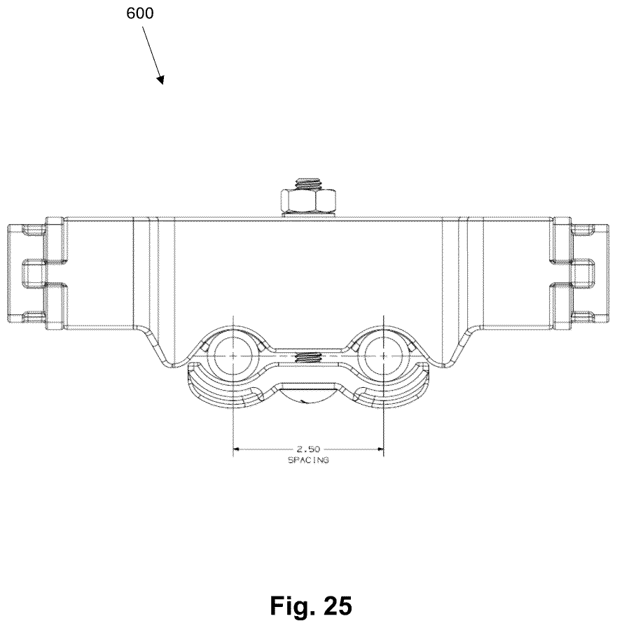

FIG. 25 shows a side view of the 2-pole keyed IPC 600 in a fully assembled state. In this fully assembled state, the insulation piercing blades 515 have pierced through the insulation jacket 301b, 302b and have made physical contact with the inner conductor 301a, 302a of the first main run cable 301 and the second main run cable 302. A spacing W between the first main run cable 301 and the second main run cable 302 may be 2.50 inches or more. According to other embodiments, the spacing W between the first main run cable 301 and the second main run cable 302 may be 2.50 inches or less.

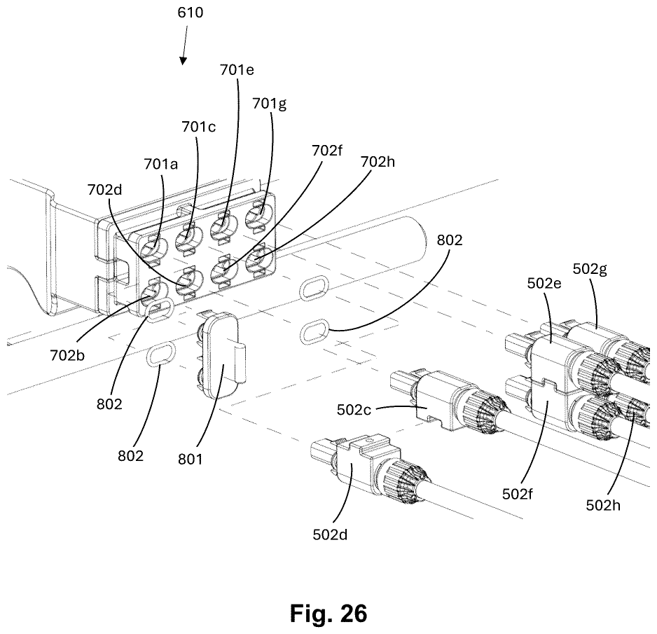

FIG. 26 shows a perspective view of the 2-pole keyed IPC 600, and in particular the first end assembly 610. As shown in FIG. 26, the first pole receptacle 701a and the second pole receptacle 702b may be covered by a blanking cap 801 used to seal up unused receptacles. O-ring seals 802 may be included for sealing the blanking cap 801 from moisture penetration. Mated safety connectors 501c, 502d may be inserted into the first pole receptacle 701c and the second pole receptacle 702d. Mated safety connectors 501e, 502f may be inserted into the first pole receptacle 701e and the second pole receptacle 702f. Mated safety connectors 501g, 502h may be inserted into the first pole receptacle 701g and the second pole receptacle 702 h.

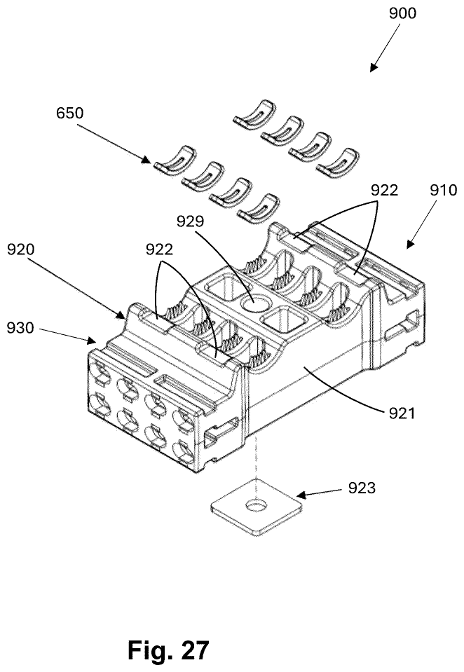

FIG. 27 shows an exemplary 2-pole keyed IPC 900, according to an alternative embodiment. The 2-pole keyed IPC 900 shares many of the same components and features with the 2-pole keyed IPC 600. For example, the 2-pole keyed IPC 900 shares the same blade seal pads 650, as well as the internal components as described for the 2-pole keyed IPC 600. However, the 2-pole keyed IPC 900 has been updated so that a main body enclosure 920 is over molded to include a one-piece design with a first end assembly 910, a second end assembly 930, and a main body 921 all molded together as a single piece. So, the first end assembly 910 is now molded together with the main body 921, and the second end assembly 930 is now molded together with the main body 921, where together the first end assembly 910, the second end assembly 930, and the main body 921 together form the single piece main body enclosure 920. This way, the safety connector ports that are included on the first end assembly 910 and the second end assembly 930 are molded directly onto the main body enclosure 920.

Otherwise, the internal coupling components and the external plug port components for the first end assembly 910 and the second end assembly 930 may be the same as from the first end assembly 610 and the second end assembly 630. The 2-pole keyed IPC 900 further includes a body reinforcement plate 923 positioned to be placed on an opposite side to a pass-through hole 929 in the main body enclosure 920.

By making the first end assembly 910 and the second end assembly 930 integrally molded with the main body 921 to form the single-piece main body enclosure 920, the design for the 2-pole keyed IPC 900 eliminates a potential moisture intrusion point that may have existed where the first end assembly 610 and the second end assembly 630 previously was detachably removable from the main body enclosure 620. This may provide the 2-pole keyed IPC 900 with a higher ingress protection (IP) rating. For example, the design for the 2-pole keyed IPC 600 may achieve an IP67 rating or greater, and the design for the 2-pole keyed IPC 900 may achieve a higher IP rating than the 2-pole keyed IPC 600. Furthermore, since the interconnect between the Barrel Connector and Terminal Pin Assemblies and the IPC Blade and Connector Pin Bus Assemblies have been replaced by spot welds, the chances of fatigue of the internal connections due to thermal cycling have been eliminated.

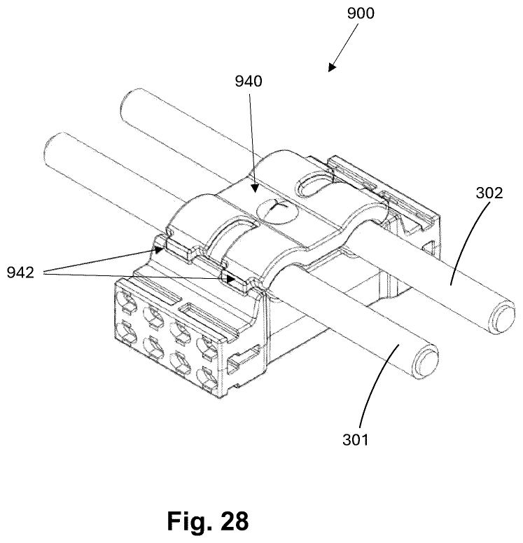

FIG. 28 shows a perspective view of the 2-pole keyed IPC 900, that further includes a slightly modified cable clamp 940 that now includes tabs 942 configured to fit into slots 922 formed at a top portion of the main body 921 to the main body enclosure 920. The slots 922 are configured to receive the tabs 942, so that when the tabs 942 are fit into the slots 922 the cable clamp 940 will be properly aligned to clamp down onto the main body enclosure 920 to hold the main run cables 301, 302.

The present disclosure thus describes a 2-pole keyed IPC as described above. 1 As is readily apparent from the foregoing, various non-limiting embodiments of the systems, devices, and methods have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. An insulation piercing connector comprising:
a main body comprising:
a first channel configured to receive a first cable, the first channel including a first opening;
a second channel configured to receive a second cable, the second channel including a second opening; and
an internal housing configured to house a first bus bar including a first insulation piercing blade protruding out of the first opening, and a second bus bar including a second insulation piercing blade protruding out of the second opening;
a first end assembly comprising:
a top row including a first pole receptacle configured to couple to the first bus bar; and
a bottom row including a second pole receptacle configured to couple to the second bus bar;
a second end assembly comprising:
a top row including a second pole receptacle configured to couple to the second bus bar; and
a bottom row including a first pole receptacle configured to couple to the first bus bar; and
a cable clamp configured to engage with the main body to clamp down on the first cable housed in the first channel such that the first insulation piercing blade pierces the first cable and clamp down on the second cable housed in the second channel such that the second insulation piercing blade pierces the second cable.

2. The insulation piercing connector of claim 1, wherein the top row of the first end assembly is further configured to include a plurality of the first pole receptacles, and the bottom row of the first end assembly is further configured to include a plurality of the second pole receptacles.

3. The insulation piercing connector of claim 1, wherein the top row of the second end assembly is further configured to include a plurality of the second pole receptacles, and the bottom row of the second end assembly is further configured to include a plurality of the first pole receptacles.

4. The insulation piercing connector of claim 1, wherein the first end assembly and the second end assembly are integrally molded with the main body enclosure.

5. The insulation piercing connector of claim 1, wherein the first end assembly and the second end assembly are detachable from the main body enclosure.

6. The insulation piercing connector of claim 1, wherein the first pole receptacle includes a first keyed feature, and the second pole receptacle includes a second keyed feature, where the first keyed feature is different from the second keyed feature.

7. The insulation piercing connector of claim 1, the main body further comprising:
a first seal pad configured to surround the first opening, and a second seal pad configured to surround the second opening.

8. The insulation piercing connector of claim 1, the main body further comprising:
a central opening configured to receive a fastener that, when tightened using a nut, engages the main body and the cable clamp together to hold the first cable within the first channel and the second cable within the second channel.

9. The insulation piercing connector of claim 1, wherein for the first end assembly, the first pole receptacle in the top row is stacked on top of the second pole receptacle in the bottom row such that the first pole receptacle and the second pole receptacle are configured to receive a duplex connector that includes two connector plug ends.

10. The insulation piercing connector of claim 9, wherein a first connector plug end in the duplex connector is configured to fit into to the first pole receptacle and corresponds to a first pole, and a second connector plug end in the duplex connector is configured to fit into to the second pole receptacle and corresponds to a second pole.
